(19) United States
(12) Patent Application Publication
(10) Pub. No.: US 2018/0222360 A1
(43) Pub. Date: Aug. 9, 2018

(54) METHOD AND DEVICE FOR ACTIVATING A VEHICLE SEAT

(71) Applicant: Robert Bosch GmbH, Stuttgart (DE)

(72) Inventor: Norman Fournier, Stuttgart (DE)

(21) Appl. No.: 15/883,996

(22) Filed: Jan. 30, 2018

(30) Foreign Application Priority Data
Feb. 6, 2017 (DE) 102017201822.4

(51) Int. Cl. B60N 2/427; B60N 2/00; B60R 21/0134; B60R 21/0136; B60R 21/015

(52) U.S. Cl. CPC B60N 2/4279; B60N 2/002; B60R 21/0134; B60R 21/0136; B60R 2021/01252; B60R 21/0153; B60N 2/42745; B60N 2/42736; B60R 21/01516

(57) ABSTRACT

A method for activating a vehicle seat including receiving a seat occupancy signal, receiving a collision signal and generating a signal for activating the vehicle seat as a function of the seat occupancy signal and of the collision signal.

### CROSS REFERENCE

The present application claims the benefit under 35 U.S.C. § 119 of German Patent Application No. DE 102017201822.4 filed on Feb. 6, 2017, which is expressly incorporated herein by reference in its entirety.

### BACKGROUND INFORMATION

Car seats adjustable with the aid of actuators, which are utilized primarily for purposes of comfort, are related art. There are functions, for example, which store person-related seat positions, which may then be automatically adjusted when needed.

Emergency brake assistants (for example, AEB), which output a warning to a vehicle occupant or carry out an automated emergency braking operation in the case of an imminent collision predicted with the aid of surroundings sensors, are also related art.

Few systems are known from the related art to date, which protect the safety of persons situated on vehicle seats in the second row of seats or in the row of seats situated further to the rear such as, for example, on the back seat in a passenger vehicle or on seats/rows of seats situated further to the rear in minivans.

The present invention provides devices and methods with the aid of which the safety of this group of vehicle occupants is enhanced.

### SUMMARY

In accordance with the present invention, a method is provided for activating a vehicle seat including the following steps:
receiving a seat occupancy signal;
receiving a collision signal;
generating a signal for activating the vehicle seat as a function of the seat occupancy signal and of the collision signal.

The seat occupancy signal may, for example, be a signal of a passenger compartment sensor system. Weight sensors and/or force sensors and/or video sensors and/or radar sensors and/or ultrasonic sensors and/or LIDAR sensors and/or infrared sensors and/or seatbelt buckle sensors and/or RFID transmitters and/or RFID receivers, for example, may be used as passenger compartment sensors. The seat occupancy signal may also be a signal, which already includes an evaluated piece of information about whether or not a seat in a vehicle is occupied. This piece of information may be conveyed, for example, in the form of an applied voltage or in the form of a digital signal. In addition, the seat occupancy signal may include additional information about the occupancy of the seat such as, for example, the weight of the object situated on the seat or of the person situated on the seat. The signal may also include a classification, which classifies the person or the object situated on the seat. Consequently, the evaluation of whether and how/with what a seat is occupied may either be a component of this method, or the previously evaluated piece of information may merely be received. The seat occupancy signal may include information about the occupancy of the vehicle seat and/or about the occupancy of additional seats situated in the vehicle. The vehicle seat and/or the seat located behind the vehicle seat may, in particular, be assigned individual seat occupancy signals. The seat situated behind the vehicle seat is understood in a passenger vehicle, in particular, to mean the seat situated directly behind the vehicle seat, in a 5-seater, for example, the right seat and/or the center seat of the rear bench seat. However, the seat occupancy signal may also include information about the occupancy of the entire rear bench seat.

The collision signal may be a signal of a crash sensor, for example, an acceleration signal of an acceleration sensor or a pressure signal of a pressure sensor. The collision signal may also be understood to mean data from surroundings sensors, such as a radar, LIDAR or a camera. In addition, the collision signal may also be a signal, which contains merely a piece of information about whether a collision exists or is imminent. This piece of information may be conveyed, for example, in the form of an applied voltage or in the form of a digital signal. In addition, the collision may include additional information about the type and severity of the collision that has already occurred or is imminent. Consequently, the evaluation whether a collision exists and of the type and severity of the collision may be a component of this method or the previously evaluated piece of information may merely be received.

A signal for activating the vehicle seat is generated as a function of the seat occupancy signal and of the collision signal. Thus, the signal is generated as a function of the instantaneous driving situation and of the occupation of the vehicle or of the occupancy of the vehicle seats. The method may run on one or on multiple control units. The airbag control unit, for example, is provided for the purpose of evaluation. Alternatively or in addition, a control unit integrated into a vehicle seat or designed for a vehicle seat may be used.

The present invention may offer the advantage that when a collision is detected or is imminent, the vehicle seat may be activated in such a way that an adjustment of the vehicle seat is carried out, which offers the greatest safety for the vehicle occupants. This ensures that the safety of the vehicle occupants is enhanced and severities of injury are reduced.

In one advantageous specific embodiment of the method, the signal for activating the vehicle seat is generated only if the seat occupancy signal indicates that the vehicle seat is not occupied by a person, in particular, is not occupied at all and, based on the collision signal, a collision has been determined or an imminent collision has been predicted.

Predicting an imminent collision may be understood to mean that an unavoidable collision is imminent or that a collision would be imminent if conditions such as position of the object or trajectory of the vehicle remained unchanged. Consequently, it is not necessary in the case of a predicted collision that a collision takes place. In some cases, a collision may be avoided by intervening in the vehicle control, in other cases as a result of a change in the position of the object of collision. Objects of collision which change their position may, for example, be humans, animals, vehicles and all other moving road users.

Different information may be obtained from the seat occupancy signal, depending on its composition. The seat occupancy signal merely indicates whether a seat is or is not occupied. Alternatively, other details may also be included such as, for example, the type of occupancy. The signal in this case may, for example, include information about the force acting on the seat and/or about the state of the seatbelt buckle; it may alternatively or in addition include other data as well. For example, it could be possible to infer data via the passenger compartment sensor system about the size and the age or, in general, about the type of object on the seat. If it is not a human, the object could then be classified accordingly. It is also possible that individual persons are recognized and, as a result, the seat occupancy signal also includes data known about the identified person not detectable with the aid of the passenger compartment sensor system, and, for example, stored in a separate memory. The seat occupancy signal also indicates, of course, that a seat that is not occupied at all, is also not occupied by a person.

This specific embodiment of the present invention has the advantage that the vehicle seat may be activated based on the generated activation signal only if the vehicle seat is not occupied by a person, as a result of which injuries to this person resulting from the activation of the vehicle seat are avoided.

In another specific embodiment of the method, the signal for activating the vehicle seat is generated only if the seat occupancy signal indicates that the seat situated behind the vehicle seat is occupied, in particular, by a person, and on the basis of the collision signal, a collision has been determined or an imminent collision has been predicted.

This condition may be combined with both previously cited specific embodiments. Either the seat occupancy signal includes exclusively information about the occupancy of the seat situated behind the vehicle seat or the seat occupancy signal also includes information about the occupancy of the vehicle seat. Alternatively, two or more seat occupancy signals may be received, at least one including information about the occupancy of the vehicle seat and at least another including information about the occupancy of the seat situated behind the vehicle seat.

In another specific embodiment of the method, the seat occupancy signal includes data detected with the aid of a passenger compartment sensor system.

This specific embodiment of the present invention offers the advantage that detailed information about the seat occupancy may be detected. Depending on the sensor system used, it is possible to recognize and/or classify objects or living beings on the seats. If the seat occupancy signal includes additional information other than merely the statement “seat occupied” or “seat unoccupied,” such information may be individually assessed in order to ultimately ensure the greatest possible safety for the vehicle occupants. If, for example, a box is buckled up on the front passenger seat, an evaluation of the signals from a weight sensor and from a belt buckle sensor would, if necessary, indicate that the seat is occupied. This message could be corrected with the aid of additional sensor signals, so that an activation of the vehicle seat, in this case, the front passenger seat, could be carried out.

In another specific embodiment of the method, the passenger compartment sensor system includes weight sensors and/or force sensors and/or video sensors and/or radar sensors and/or ultrasonic sensors and/or LIDAR sensors and/or infrared sensors and/or belt buckle sensors and/or RFID transmitters and/or RFID receivers.

This specific embodiment of the present invention offers the advantage that different pieces of information about the occupancy of a seat are detectable with the aid of this passenger compartment sensor system. The method may be improved as a result of the additional information, thereby enhancing the safety of the vehicle occupants.

In addition to the method, a control unit is also provided. This control unit includes an interface for receiving a seat occupancy signal and/or a collision signal, an interface for emitting a signal for activating a vehicle seat, and a processing unit that is configured to carry out one of the specific embodiments of the method outlined above.

The above described method may, of course, also be carried out on multiple separate control units, each of which carries out separate method steps.

A vehicle seat for a vehicle is also provided. This vehicle seat includes an actuator for activating the vehicle seat. The vehicle seat is distinguished by the fact that, in the case of a collision or of an imminent collision of the vehicle and when a vehicle seat is not occupied by a person, it may be activated in such a way that the forward space delimited by the seat back of the vehicle seat increases between the vehicle seat and the seat situated behind the vehicle seat.

The delimited space in most passenger vehicles is the space between the vehicle rear bench seat and the front seats, i.e., driver seat or front passenger seat. In the case of vehicles presently travelling primarily on roads, it is expedient to initially design the front passenger seat in such a way that it is activatable in the case of a collision or of an imminent collision in a manner similar to the above described vehicle seat. If in the future, vehicles drive in a highly automated manner or in a fully automated manner, it is no longer mandatory for one of the front seats to be occupied. Consequently, in the case of vehicles driving in a highly automated manner or in a fully automated manner, all seats behind which an additional seat is situated on which persons may be seated, could be designed in accordance with the vehicle seat described above.

The delimited space may be increased by activating the seat in various ways.

In one specific embodiment of the seat, the seat back of the vehicle seat is configured to carry out a forward rotational movement when the vehicle seat is activated.

This movement of the seat back is already manually triggerable in many vehicles, for example, in order to reach the rear bench seat in a three-door vehicle. This movement could be carried out via a corresponding actuator in very short periods of time, preferably in a few milliseconds. If a collision is recognized early, slower movements are then also sufficient, so that a few seconds for adjusting the seat would also be adequate.

In another specific embodiment, the vehicle seat, when activated, is configured to carry out a forward translational movement.

This movement of the seat is also already possible today in virtually every vehicle and also enables an effective increase of the delimited area. To carry out this movement, a corresponding actuator is installed in the seat, which may be operated electrically, pyrotechnically or with gas, for example. Here, too, the change of the seat position should be possible optimally in less than one second, so that the movement is carried out in a timely manner before the occupant situated on the rear seat strikes the seat.

In another specific embodiment of the vehicle seat, the vehicle seat, when activated, is configured to carry out a rotation movement, so that the position of the seat back changes and the delimited space is increased.

The seat in this case is rotated preferably about an axis oriented approximately at a right angle to the sitting surface of the vehicle seat, which passes preferably through a point near the center point of the sitting surface. The rotation about the axis thus defined has the advantage that the seat requires preferably little space in the vehicle for its rotation. Other rotation axes may, of course, also be selected, as long as the space for a rotation of the seat is sufficient.

In the future, such a rotational movement could be increasingly demanded in vehicles, in particular, if these vehicles are operating in a highly automated or fully automated manner. In this way, a rotation of the front seats could allow vehicle occupants to communicate more easily with persons on the rear seats.

In another specific embodiment, the vehicle seat includes at least one means, with which the vehicle seat is activatable only when the vehicle seat is not occupied by a person in such a way that the delimited space is increased.

In this specific embodiment, the vehicle seat includes, for example, a mechanical device or an electronic control unit, with the aid of which an activation of the seat for increasing the delimited space is suppressed, in the event a person is situated on the vehicle seat. This ensures that no activations of the vehicle seat occur if persons are situated on the seat. Since the persons could be harmed by an activation, the safety of the vehicle occupants is further enhanced by the implementation of a corresponding means.

In another specific embodiment, the vehicle seat includes means, with which the vehicle seat is activatable only in the event of a collision or of an imminent collision of the vehicle and when the vehicle seat is not occupied by a person, in such a way that the delimited space is increased.

In this specific embodiment, the vehicle seat includes the necessary intelligence in order for it to carry out one of the above described methods itself. The vehicle seat either receives the information about an occupancy state or evaluates this information itself based on sensor data, for example, from the passenger compartment sensor system. In one preferred variant of the present invention, the vehicle seat receives the piece of information about whether a collision is imminent. Alternatively, the seat itself could deduce an imminent collision or occurring collision based on sensor data, for example, from surroundings sensors. However, this analysis is preferably carried out in a separate control unit, so that the seat includes a significantly reduced piece of information or, if necessary, only one activation signal. The vehicle seat may be activated, if it is also determined with the aid of the installed means that the vehicle seat is not occupied by a person.

Depending on the functional range and the specific embodiment of the vehicle seat, the means may include either a mechanical device or an electronic control unit. In one specific embodiment of the seat, the seat includes the above described control unit for carrying out one of the methods also described above.

### BRIEF DESCRIPTION OF THE DRAWINGS

FIG. 1 schematically shows a flow chart.

FIGS. 2A and 2B show exemplary embodiments of a vehicle seat.

FIG. 3 schematically shows a flow chart.

FIG. 4 schematically shows a flow chart.

### DETAILED DESCRIPTION OF EXAMPLE EMBODIMENTS

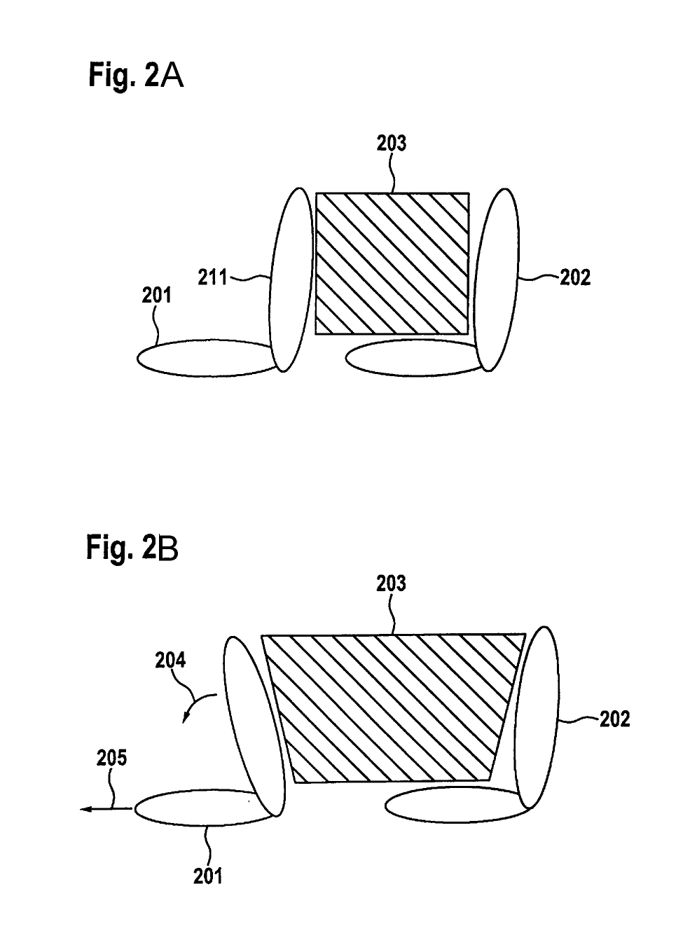

In a first exemplary embodiment, a vehicle includes a vehicle seat 201, which is depicted in FIG. 2, a passenger compartment sensor system, a crash sensor system, a surroundings sensor system and a seat 202 situated behind the vehicle seat. Vehicle seat 201 in this case is allocated a control unit, with which vehicle seat 201 may be activated.

A space 203, which is available to an occupant on rear seat 202 for deceleration in the event of a collision, is delimited by seat back 211 of vehicle seat 201 and the seat situated behind the vehicle seat. This space 203 may be increased by changing the position of vehicle seat 201 or of seat back 211 thereof. To increase space 203, the vehicle seat in this exemplary embodiment may fold its seat back 211 forward via a rotation movement 204. Vehicle seat 201 may also move forward via a translational movement 205, so that space 203 is also increased. The increase of space 203 is illustrated by FIG. 2a) and FIG. 2b). Pyrotechnical actuators are installed in the vehicle seat for carrying out translational movement 205 and rotation movement 204, which move the seat into the changed position (FIG. 2b) in less than one second.

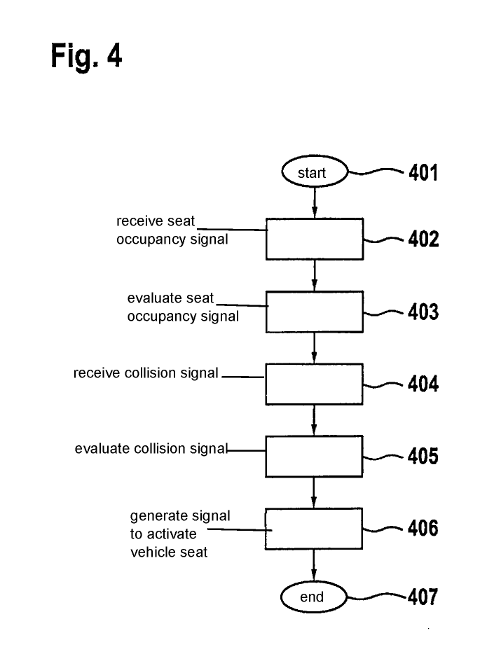

In order to avoid unnecessarily or inadvertently activating vehicle seat 201, the method shown in FIG. 4 is carried out on the control unit allocated to vehicle seat 201. This method starts in step 401.

In step 402, a seat occupancy signal is received. In this exemplary embodiment, this signal includes both information about the seat occupancy of vehicle seat 201, as well as information about the occupancy of seat 202 situated behind the vehicle seat. The seat occupancy signal in this case includes data from the passenger compartment sensor system installed in the vehicle, which includes seat mats, an interior camera and belt buckle sensors.

In step 403, an evaluation of the seat occupancy signal takes place. In the process, it is ascertained which seats are occupied. If a seat is occupied, an attempt is made, based on the seat occupancy signal/the data of the passenger compartment sensor system, to ascertain whether a person or an object is situated on the vehicle seat.

In step 404, a collision signal is received, which includes data of the passenger compartment sensor system made up of a camera, a radar sensor and a LIDAR sensor, and data of the crash sensor system, made up of multiple acceleration sensors, rotation rate sensors and pressure sensors.

This collision signal is evaluated in step 405. In the process, it is ascertained with the aid of conventional algorithms whether a collision has taken place or is immediately imminent.

In step 406, a signal for activing vehicle seat 201 is generated as a function of the evaluated seat occupancy signal and of the evaluated collision signal. In this exemplary embodiment, the signal is generated only if the seat occupancy signal indicates that vehicle seat 201 is not occupied by a person and seat 202 situated behind the vehicle seat is occupied by a person. In addition, the signal is generated only if the collision signal indicates that a collision of the vehicle with another object is imminent or has already taken place.

The method ends in step 407.

Different control units may be used to generate the signal for activating the vehicle seat. The method may, for example, run on the airbag control unit or in a separate control unit provided specifically for the vehicle seat.

In another exemplary embodiment, the signal for activating the vehicle seat is generated regardless of the occupancy of seat 202 situated behind vehicle seat 201, which occupancy is also not compulsorily ascertained. Vehicle seat 201 in this exemplary embodiment is activated with the aid of an electric motor and is therefore implementable reversibly/multiple times.

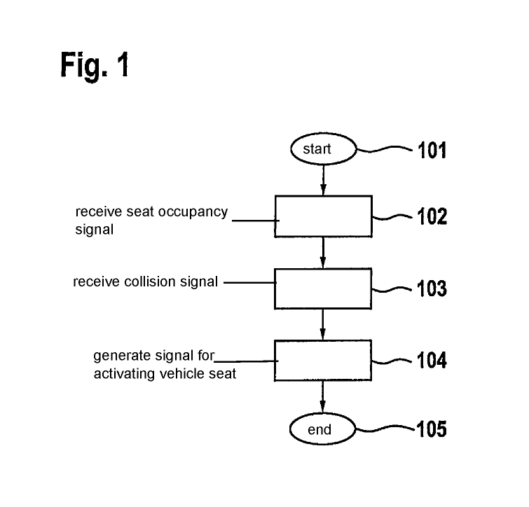

In another exemplary embodiment, the functional range of the control unit assigned to vehicle seat 201 is designed even more simply. The method depicted in FIG. 1, which starts in step 101, runs on this control unit.

In step 102, a seat occupancy signal is received by the control unit and in step 103, a collision signal is received. The signals in this exemplary embodiment already include fully processed information. The seat occupancy signal indicates which seats are occupied by persons and the collision signal indicates whether a crash exists or is imminent.

The signal for activating the vehicle seat in step 104 is generated here also as a function of the seat occupancy signal and of the collision signal, with the difference that both signals are not evaluated in this control unit. The signal in this exemplary embodiment is generated only if no person is situated on the vehicle seat and a collision or an imminent collision has been recognized.

The method ends in step 105.

The collision signal in this exemplary embodiment is generated in an airbag control unit and conveyed by the airbag control unit to the control unit assigned to the seat. Different surroundings sensors and crash sensors are available to the airbag control unit for generating the collision signal. A crash detection takes place on the basis of these sensor data. In this way, it may be ascertained with the aid of known algorithms whether a collision is imminent and when and with what probability this crash is imminent. It may also be ascertained whether a collision has already taken place and how far along this collision has already progressed. The severity of a collision may also be ascertained and assessed. This assessment may also be made a condition of the signal generated for activating the seat or of the generation of the signal.

The generation of the seat occupancy signal in this exemplary embodiment also takes place in a separate unit. In this unit, data from a passenger compartment sensor system installed in the vehicle are evaluated and the occupancy of all seats is determined. After this determination, a seat occupancy signal is conveyed to the control unit assigned to the vehicle seat, which includes the evaluated information about the occupancy of the seats.

In another exemplary embodiment of the method, the seat occupancy signal received in step 102 includes merely the piece of information regarding whether the vehicle seat is occupied. It includes no further information such as, for example, whether a person or an object is situated on the seat. The collision signal received in step 103 also merely includes the piece of information that a risk of collision exists and no further information. The signal for activating the vehicle seat in step 104 is generated in this example, if the vehicle seat is not occupied and a risk of collision exists.

In another exemplary embodiment, the collision signal is generated based only on data of a surroundings sensor system in a surroundings sensor system control unit and conveyed to the control unit assigned to the seat. In this exemplary embodiment, immediately imminent collisions may be conveyed directly to the control unit assigned to the vehicle seat, and more time may be gained by omitting the airbag control unit (i.e., without taking the crash sensor signals into account).

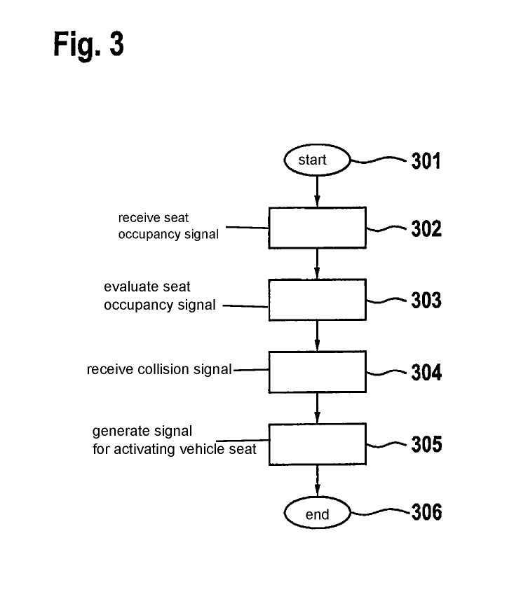

FIG. 3 depicts another exemplary embodiment of the method, which runs in a control unit assigned to the driver's seat. This method starts in step 301.

In step 302, a seat occupancy signal is received by this control unit, which includes data from a passenger compartment sensor system installed in the vehicle.

These data are evaluated in step 303. In the process, it is ascertained for each seat whether or not the seat is occupied. In the case of an occupancy, a classification is also carried out, thereby making it possible to distinguish between objects and persons.

In step 304, a collision signal is received from the control unit, which includes previously evaluated information about whether a collision has taken place or is imminent.

In step 305, a signal for activating the vehicle seat is generated on the basis of the collision signal and of the evaluated seat occupancy signal.

The method ends in step 306.

In this exemplary embodiment, vehicle seat 201 is designed in such a way that the entire seat is rotatable about an approximately vertical axis. As a result, seat back 211 may be rotated to the side or completely forward in the direction of the vehicle instrument panel. This type of rotation also significantly increases delimited space 203.

What is claimed is:

1. A method for activating a vehicle seat, comprising:
receiving a seat occupancy signal;
receiving a collision signal; and
generating a signal for activating the vehicle seat as a function of the seat occupancy signal and the collision signal.

2. The method as recited in claim 1, wherein the signal for activating the vehicle seat is generated only when the seat occupancy signal indicates that the vehicle seat is not occupied by a person and one of: (i) a collision is determined based on the collision signal, or (ii) an imminent collision has been predicted.

3. The method as recited in claim 1, wherein the signal for activating the vehicle seat is generated only when the seat occupancy signal indicates that the seat situated behind the vehicle seat is occupied by a person, and one of: (i) a collision is determined based on the collision signal, or (ii) an imminent collision has been predicted.

4. The method as recited in claim 1, wherein the seat occupancy signal includes data detected with the aid of a passenger compartment sensor system.

5. The method as recited in claim 4, wherein the passenger compartment sensor system includes at least one of weight sensors, force sensors, video sensors, radar sensors, ultrasonic sensors, LIDAR sensors, infrared sensors, belt buckle sensors, RFID transmitters, and RFID receivers.

6. A control unit, comprising:
an interface for receiving at least one of a seat occupancy signal and a collision signal;
an interface for emitting a signal for activating a vehicle seat; and
a processing unit that is configured to receive the seat occupancy signal, receive the collision signal, and generate the signal for activating the vehicle seat as a function of the seat occupancy signal and the collision signal.

7. A vehicle seat for a vehicle, comprising:
an actuator for activating the vehicle seat;
wherein in the event of one of a collision or of an imminent collision of the vehicle, and when the vehicle seat is not occupied by a person, the vehicle seat is activated in such a way that a forward space delimited by a seat back of the vehicle seat increases between the vehicle seat and a seat situated behind the vehicle seat.

8. The vehicle seat as recited in claim 7, wherein the seat back of the vehicle seat is configured to carry out a forward rotation movement when the vehicle seat is activated.

9. The vehicle seat as recited in claim 7, wherein the vehicle seat is configured to carry out a forward translational movement when the vehicle seat is activated.

10. The vehicle seat as recited in claim 7, wherein the vehicle seat is configured to carry out a rotation movement when the vehicle seat is activated, so that a position of the seat back changes and the delimited space is increased.

11. The vehicle seat as recited in claim 7, wherein the vehicle seat includes at least one device, with which the vehicle seat is activatable in such a way that the delimited space is increased, only when the vehicle seat is not occupied by a person.

12. The vehicle seat as recited in claim 7, wherein the vehicle seat includes at least one device, with which the vehicle seat is activatable in such a way that the delimited space is increased, only in the event of one of a collision or of an imminent collision of the vehicle, and when the vehicle seat is not occupied by a person.

13. The vehicle seat as recited in claim 11, wherein the device is one of a mechanical device or an electronic control unit.

14. The vehicle seat as recited in claim 11, wherein the device is a control unit including an interface for receiving at least one of a seat occupancy signal and a collision signal, an interface for emitting a signal for activating the vehicle seat, and a processing unit that is configured to receive the seat occupancy signal, receive the collision signal, and generate the signal for activating the vehicle seat as a function of the seat occupancy signal and the collision signal.
